(19) United States
(12) Patent Application Publication
(10) Pub. No.: US 2015/0379807 A1
(43) Pub. Date: Dec. 31, 2015

(54) GAMES WITH SPECIAL REGIONS ACTING ON SYMBOLS IN A SYMBOL ARRAY

(71) Applicant: Multimedia Games, Inc., Austin, TX (US)

(72) Inventors: Cameron Zhang, Austin, TX (US); Brian Alexander Watkins, Austin, TX (US); Mike Wabschall, Austin, TX (US)

(21) Appl. No.: 14/317,257

(22) Filed: Jun. 27, 2014

(51) Int. Cl. G07F 17/32; G07F 17/34

(52) U.S. Cl. CPC G07F 17/3213; G07F 17/34

(57) ABSTRACT

A slot machine game provides a special region that appears before reels stop spinning, and is defined independently of the symbols within it. The region is activated and placed into randomized game results, using foreknowledge of the spin result while the reels are shown to the player to still be spinning. The region acts upon the symbols that stop inside it in various ways. Awards may be provided that are independent of any other awards in the game result. Eligible symbols may be enhanced in various ways such as being made wild. Other awards may be based on how many of a certain type of symbol land in the special regions. The regions may appear in base or bonus games and may persist between spins.

### TECHNICAL FIELD OF THE INVENTION

The invention relates to methods for conducting an interactive reel or symbol array type wagering game including a special region defined independently of the symbols within it, which acts upon symbols.

### BACKGROUND OF THE INVENTION

Various slot machine games use features that enhance certain game symbols to improve the game experience for games with reels, simulated reels, or other arrays of gaming symbols. For example, many slot machines have features that turn certain symbols wild in certain situations, or provide various enhancements to the symbols in a spin result that provide for higher prizes when the result is evaluated.

What is needed are more exciting variations for the creation and use of symbol enhancements in order to increase player excitement and enjoyment of slot machine games.

### SUMMARY OF THE INVENTION

The present invention includes a highly entertaining method of conducting a game for one or more players. The entertainment value is achieved by a slot machine game with a special region that appears before reels stop spinning, and is defined independently of the symbols within it. The region is activated and placed into randomized game results, using foreknowledge of the spin result while the reels are shown to the player to still be spinning. The region acts upon the symbols that stop inside it in various ways. Awards may be provided that are independent of any other awards in the game result. The special region may also enhance the symbols therein in their evaluation of the paylines in the spin result, such as by turning eligible symbols wild. Other awards may be based on how many of a certain type of symbol land in the special regions. The regions may appear in base or bonus games and may persist between spins.

Another version of the invention is a computer program stored on a non-transitory readable medium. The software version is, of course, typically designed to be executed by a gaming machine or networked gaming system. The software includes multiple portions of computer executable code referred to as program code. Gaming results are provided in response to a wager and displayed by display program code that generates simulated slot reels each including one or more symbol locations. The program also has game controller program code for determining game play results involving spins or other randomization of an array of symbols, each spin producing a spin result, each spin result having a chance to include one or more of the special regions.

Another version of the invention is a gaming system that includes one or more gaming servers, and a group of electronic gaming machines connected to the servers by a network. The various functionality described herein may be distributed between the electronic gaming machines and the gaming servers in any practically functional way. For example, the current preferred architecture is for the servers to determine all aspects of game logic, random number generation, and prize awards. The gaming machines provide functionality of interfacing with the player and animating the game results received from the server in an entertaining manner. However, other embodiments might use a thin client architecture in which the animation is also conducted by the server, and electronic gaming machines serve merely as a terminal to receive button or touch screen input from the player and to display graphics received from the server.

Different features may be included in different versions of the invention. For example, different animation themes may be applied that display the application of the special region in different ways.

These and other advantages and features of the invention will be apparent from the following description of the preferred embodiments, considered along with the accompanying drawings.

### BRIEF DESCRIPTION OF THE DRAWINGS

FIG. 1A shows an example game screen diagram showing a special region feature according to one embodiment.

FIG. 1B shows another example game screen diagram with a different special region feature according to another embodiment.

FIG. 2A is a flow chart showing the general method of play for an example embodiment including special regions according to one embodiment the invention.

FIG. 2B is a flow chart showing a game method using a special region feature according to another embodiment.

FIG. 2C is a flow chart of an embodiment in which special regions are used in a free-spin bonus round.

FIG. 3A is a front perspective view of a gaming machine which may be used in a gaming system embodying the principles of the present invention.

FIG. 3B is a block diagram showing various electronic components of the gaming machine shown in FIG. 3A together with additional gaming system components.

FIG. 4A is a system block diagram of a gaming system according to one embodiment of the present invention.

FIG. 4B is a system block diagram of a gaming system according to another embodiment.

### DETAILED DESCRIPTION OF PREFERRED EMBODIMENTS

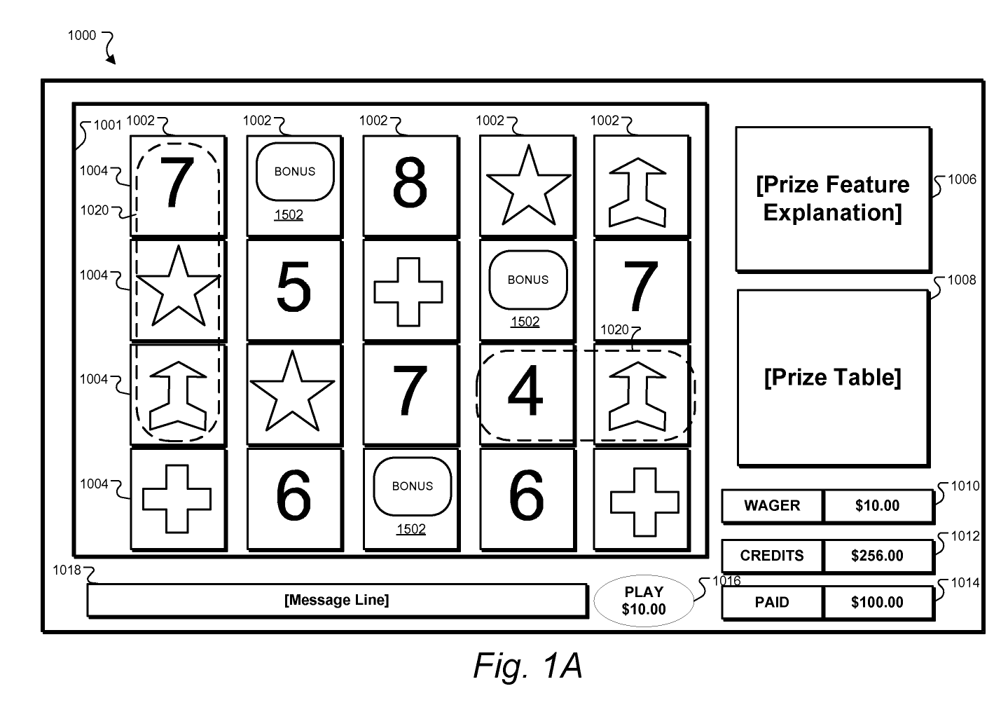

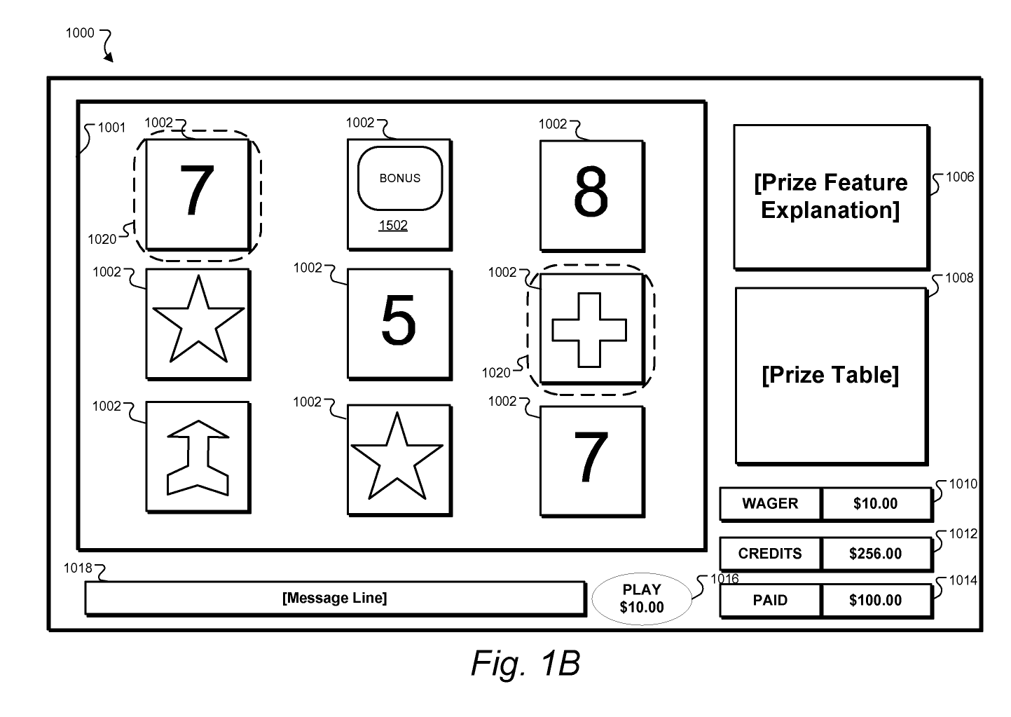

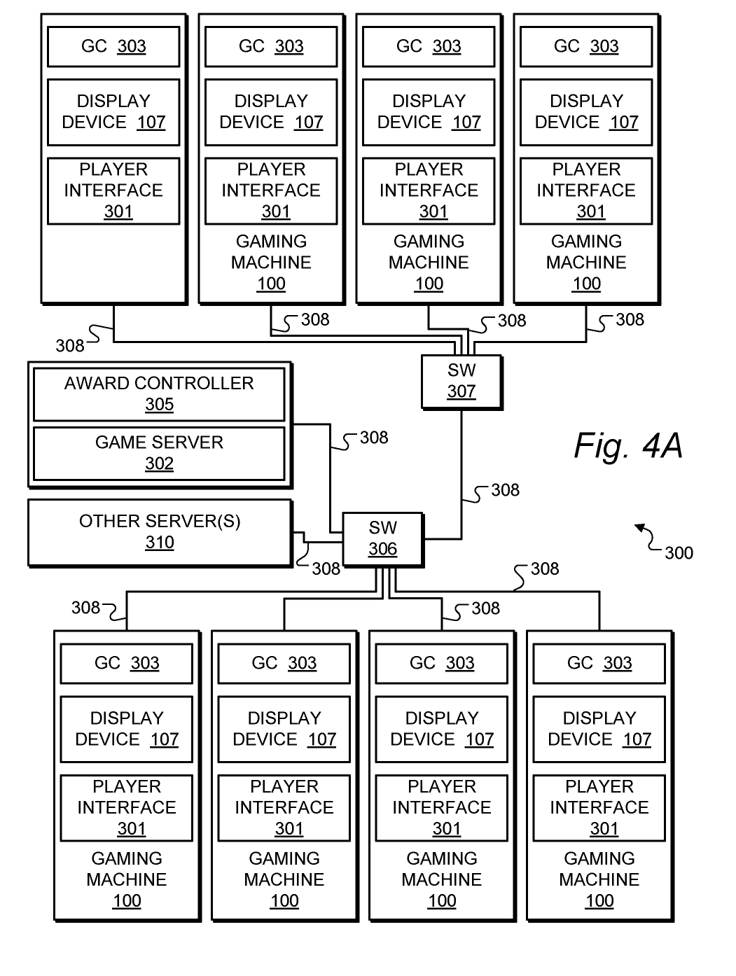

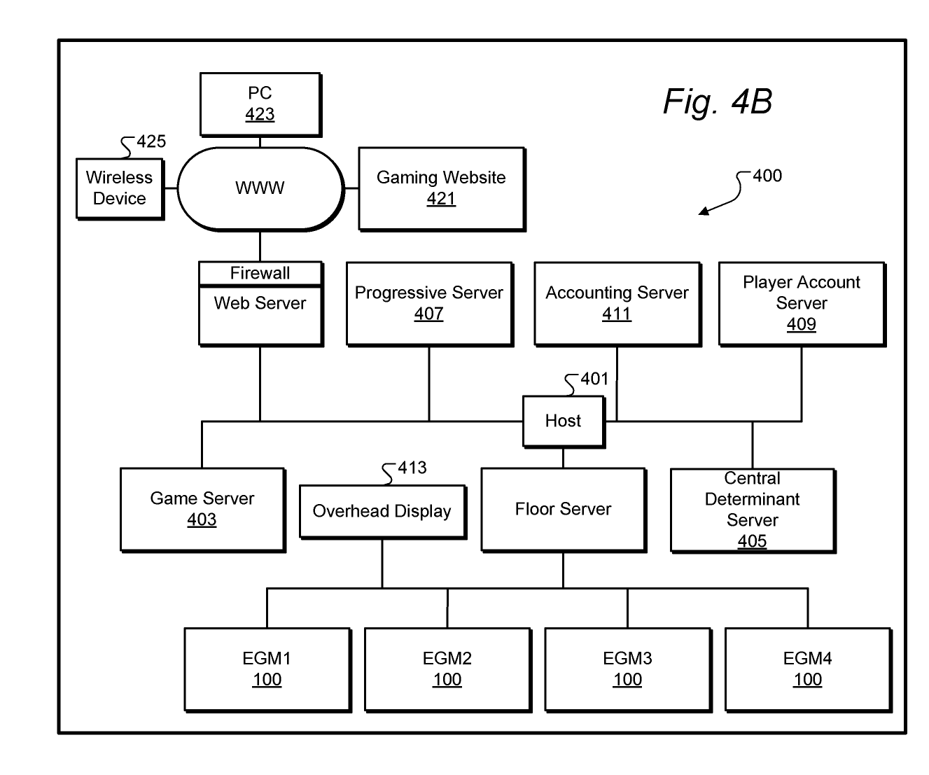

FIG. 1A shows an example game screen diagram 1000, which would be displayed at various gaming machines 100 shown in FIG. 4A to implement the special region feature of the invention. In this embodiment, the graphic display includes a matrix of symbol locations 1001 (“matrix”, “array”) that displays symbols in four symbol locations 1004 on each of five separate reels 1002. The graphic display 1000 also includes a box 1006 for displaying texts regarding prize features. There may also be displayed a prize table 1008. A group of accounting indicators at the lower right displays various pieces of data such as the current wager box 1010, available credits 1012, and/or payouts 1014. The touch screen play button 1016 also displays the wager for each game 1016. A message line 1018 displays messages concerning game progress, results, and related information.

In this embodiment of the invention, a slot machine reel game employs the special regions 1020 that appear in the base game play or the bonus game, these special regions having special properties and rules that apply to their location, and are preferably depicted appearing on the matrix 1001 as the reels 1002 are shown to be spinning. Depicted in the base game result shown in matrix 1001 are two such special regions 1020. While the matrix 1001 is depicted with the symbols present in symbol locations 1004, the special regions 1020 appear on the matrix 1001 while the reels 1002 are spinning, and certain game logic is conducted while the reels are spinning, as further described below.

FIG. 1B is a game screen diagram showing an alternative matrix of symbol locations with a different type of special region feature. In this version of the game screen diagram 1000, unisymbol reels 1002 are used, in which each location in the matrix presents a single location of a single simulated reel 1002, rather than multiple symbol locations per reel as depicted in FIG. 1A. Unisymbol reels are known in the art and typically have less symbols total around the diameter of the simulated reel than multisymbol reels. Because only one symbol from each reel is shown at a time, less symbols are needed on each reel to achieve significant variations among symbols in the matrix. Depicted on the array 1001 are two special regions 1020, which each surround, cover, or include a symbol location. While the Figure shows the symbol locations of each reel 1002 being populated with symbols, the preferred embodiments of the invention function to show the special regions surrounding their respective locations while the reels are still spinning, as is further described below.

While two variations of reel-type games are shown, the techniques herein may be employed with any suitable slot machine games that use randomized groups of symbols as the basis of the games.

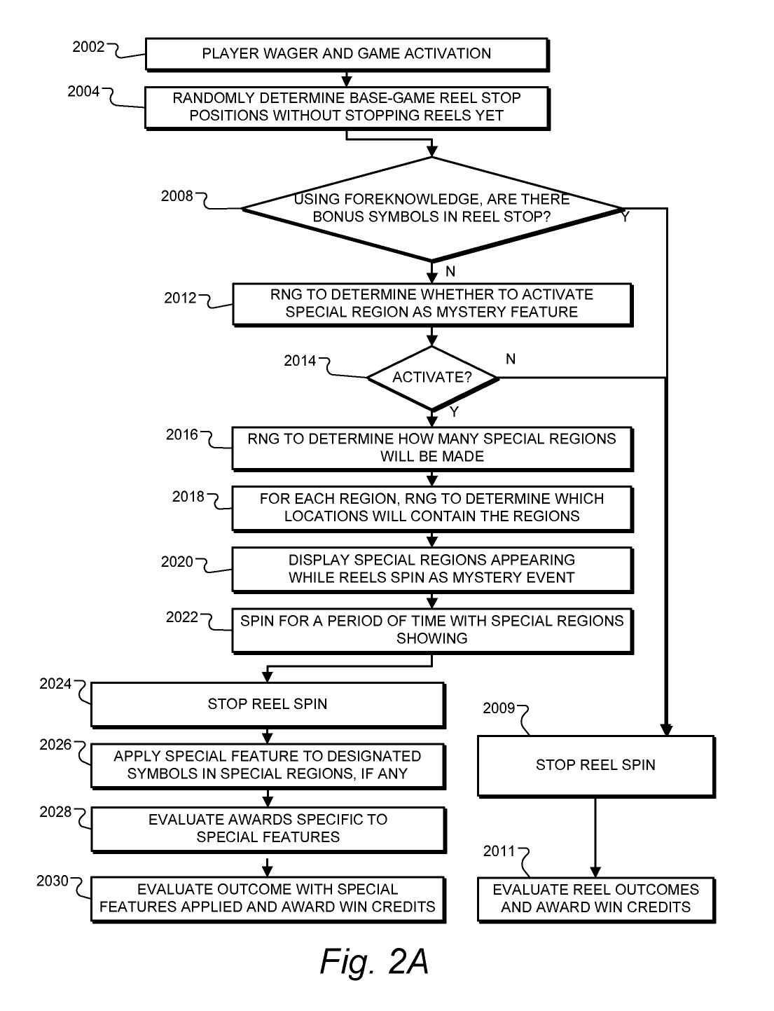

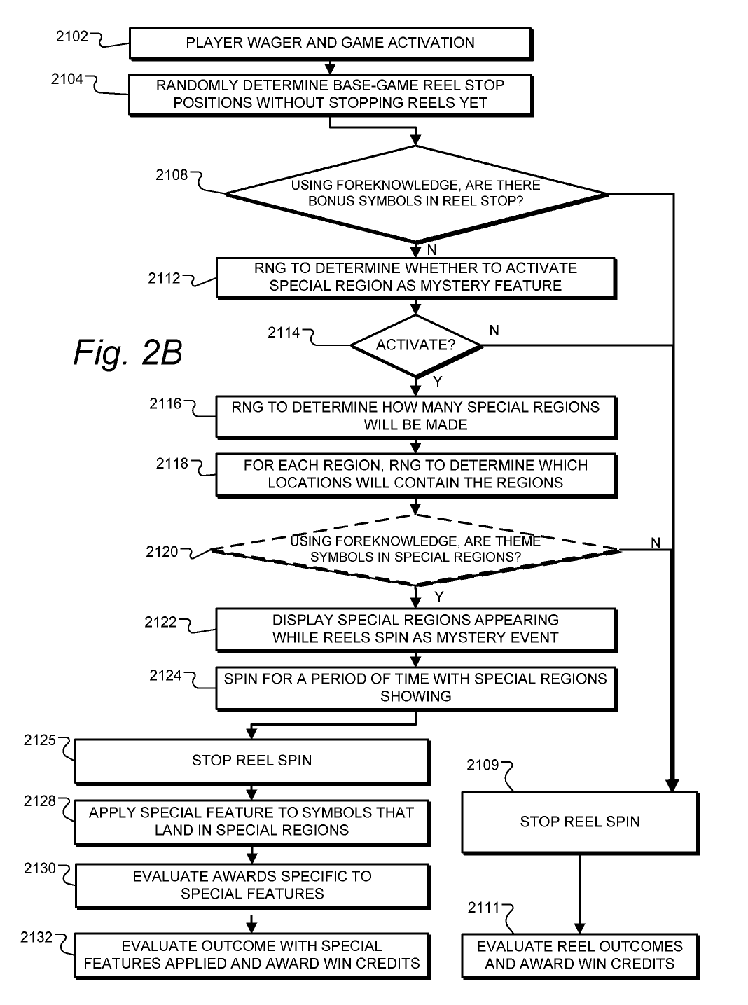

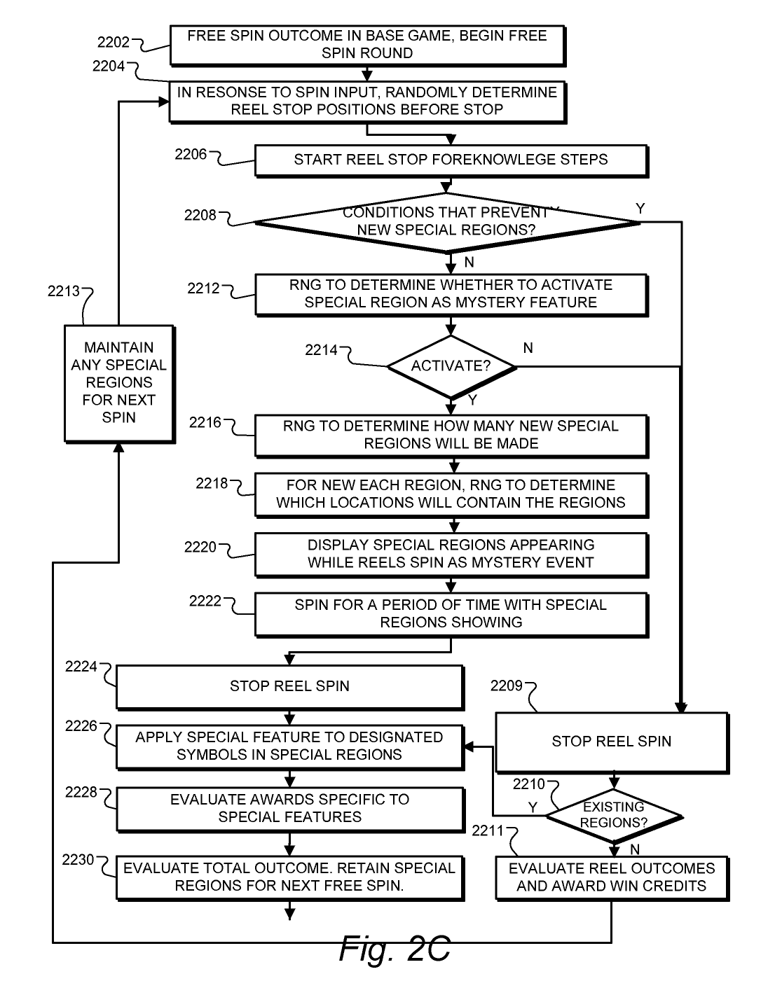

FIG. 2A is a flow chart showing the general method of play for an example embodiment including special regions according to one embodiment of the invention. The depicted method preferably takes place in the context of the base game, but may also be employed in the context of a bonus game round. In fact, one preferred embodiment includes a bonus round of multiple free spins in which every free spin may have at least one special region. In such a case, the wager portion of step 2002 is obviously skipped for the free spins, and a base game round with a free spin award must precede the bonus round. In another embodiment, a free spin bonus round has special regions that persist for more than one free spin. Such an embodiment is described below with respect to FIG. 2C.

Referring to FIG. 2A, the depicted method begins with displaying an initial state of the array which typically includes some arrangement of symbols in the symbol locations of the array. To begin a game play, the method receives a wager from the game player at step 2002, which typically consists of some input from the player to set the amount to be wagered from their credit amount on the machine. This step may also be carried over from previous game rounds by simply starting the game with the previous wager amount set. Then, the method receives a play input from the player. This typically happens through a ‘Play’ button on the game cabinet or touchscreen display, and serves to place the wager and start a single round of game play in the base game. The method also begins conducting the activated game by showing the matrix of symbols being scrambled. In embodiments having reels, reels displays, or simulated reels, this is conducted by spinning the reels. Other embodiments may otherwise rearrange or randomize the symbols on the matrix in any suitable manner. The particular point at which the scrambling or simulated reel spinning starts is not critical to the method described below, but the point at which the reels stop spinning is important because several game logic steps must be completed before the game results area is shown to the player in preferred versions.

After the game activation in step 2002, the method randomly determines a set of reel stops that determine which symbols fill the matrix for the current game outcome at step 2004. For games that use other scrambling besides simulated reels, the random outcome is determined at this step as appropriate for the game. The preferred version generates at least one random number and using the at least one random number to determine a set of game reel stops specifying a position in which multiple simulated or mechanical reels will stop to display symbols in a symbol array in a spin outcome for the wager. After determining the set of reel stops, the method takes at least one step that uses foreknowledge of the reel stops before the reels stop spinning, as shown at step 2008. This includes at least making a decision whether to use or activate a special region feature depending on whether a designated type of bonus symbols or, in other versions, a designation bonus winning combination of bonus symbols, will stop in the symbol array, as shown at step 2008. In different embodiments, there are different ways to determine whether the special region feature will activate.

In the preferred version of FIG. 2A, there is a type of bonus symbol that activates other features of the game, which are not provided at the same time as the special region feature according to the game rules. Therefore, the method uses foreknowledge of the spin results to determine if such bonus symbols are present in the spin result, at step 2008. If so, the method goes to step 2009 where the special regions are not used and the reel spin is stopped and evaluated according to the game rules at step 2011.

If, back at step 2008, there are none of the prohibited type of bonus symbols present in the foreknowledge of the spin result, the method goes to step 2012, where it randomly determines whether a special region mystery feature will activate, and if not, goes to step 2009. Preferably, this random determination is made with a single additional random number generation, which is matched to a range to determine a positive or negative answer to activating the special region bonus feature. If activated at step 2014, the method goes to step 2016, where it begins a more detailed sequence of determining exactly how special regions will deploy on the matrix 1001. Note that this is one version of how special regions may be deployed, and many variations exist.

If the special region mystery feature will activate at step 2014, the method next (i) randomly determines how many special regions will be used at step 2016 (preferably using another random number generation), then (ii) for each special region to be used, randomly determining which position(s) of the symbol array will contain the special region (again preferably using another random number generation for each region to deployed, and matching those numbers to predefined regions in the matrix). Next, the method (iii) displays the special regions appearing as a mystery feature while the reels are shown to be spinning at step 2020. This is done by displaying at least one special region appearing to surround, cover, or include one or more designated locations in the symbol array before the reels stop spinning. Finally, the method (iv) continues to spin the reels for a period of time displaying the special regions in place on the symbol array as shown at step 2022.

Generally, the foreknowledge decision at step 2008 may use different techniques for determining if the special region feature will deploy. If the method determines to use the special region feature, it will then always display at least one special region appearing to surround, cover, or include one or more designated locations in the symbol array before the reels stop spinning. The preferred versions display the special region while the reels are still spinning, or the matrix is shown as being scrambled.

Next the method at step 2024 stops the reels to show symbols occupying respective symbol locations in the matrix, including those symbols that stop within a special region. Next at step 2026, the method applies a special feature to any designated symbols that stop in any special regions and evaluating awards that result therefrom. In one preferred version, the special regions award a specific award if a designated symbol lands in a special region, the specific award being independent of any other award provided for the spin outcome. Special features are then evaluated at step 2026, whether they are independent, such as an award for a theme symbol that lands in a special region, or dependent, such as turning symbols in the region wild. Any independent awards are given at step 2028, along with other evaluations specific to special features. Finally, at step 2030 the whole matrix is evaluated for paylines according to the game rules.

A preferred embodiment of the invention appears in Multimedia Games® fishing themed slot game entitled “Off The Hook”. In this game, unisymbol reels are used as in FIG. 1B. The special zones are represented as a “bobber” that each lands on a specific reel during the reel spin to designate the unisymbol reel as a special region. If any of a designated group of fish symbols spin up on that region, that fish is designated as “caught” and a special bonus award is won independent of the payline awards and other bonus awards that evaluate from the complete matrix according to the game rules.

FIG. 2B is a flow chart showing a game method using a special region feature according to another embodiment. In this variation, embodied in Multimedia Games® slot game entitled “Reef Kingdom,” five four-symbol multisymbol reels are used like the matrix in FIG. 1A. This game method proceeds similarly to the method of FIG. 2A, but it has an additional step which uses reel foreknowledge to implement game rules based on which symbols would eventually land on special regions after the regions are designated. Referring to step 2118, the special regions are designated but not yet shown on the spinning reels as described above. The added step is next at step 2120, which is shown with a dotted decision box. Step 2120 determines whether there would be any symbol of a particular theme symbol type in the special regions, were the regions to be used with this already known reel stop outcome. If not, then the game does not use the special region feature at all, and goes to step 2109. If so, the game proceeds to step 2122, where it displays the special regions, then stops the reels, and evaluates the results including the theme type symbols appearing on the special regions. In the preferred version, each special region is represented by coral reef graphics that are shown to surround a group of symbol locations at step 2122. Any of a designated group of reel symbols, in this case four different animal symbols, which land in the special region turn wild. Such a feature may be employed in games where the rules of the game say a special region confers a prize enhancement only on a theme type of symbol, which has no other enhanced function in a spin result besides that conferred by the special region. In that case, taking steps using the foreknowledge of reel stops to remove the special regions from results where they would otherwise appear avoids player disappointment, or complicating the game design mathematically.

The special regions may be employed in the game rules to have various types of enhancement properties, which may be independent of any other prize in the spin result, or may enhance a prize in the spin result. That is, the special region is applied to the symbols that land on it, and may confer an independent award, an independent award enhancement, or a dependent award enhancement. For example, the region may award a multiplier value which applies to the total win on the spin based on the number of eligible symbols that land in the special region. It may award a number of free spins for each eligible symbol that lands in the eligible region. Further it may award a progressive tier based on the number of eligible symbols that land in the eligible region. It may further confer known award enhancements such as turning symbols wild, multiplying awards for paylines, multiplying symbols to adjacent locations, annulling symbol affects, adding paylines, or other suitable variations to array-type slot machine games.

While the description above shows two special regions in each example, this is not limiting and various game designs may use the regions in any suitable number, shape, and direction. One version makes an entire multisymbol reel into a special region for each region. Another game makes a single unisymbol reel symbol location into a special region for each region. Other versions have special regions that span multiple reels, and may have multiple dimensions and uneven shapes according to any suitable design. Further, while a random number generation is described to determine how many regions there are, and another to determine what locations(s) each region will cover, this is not limiting and other methods may be used to place the special regions on the game array. For example, a one step process may be used in which random numbers are drawn that correspond directly (with no probability distribution) to a location or to a reel, to determine that the location or reel will be covered by a special region. Other versions may use a probability distribution mapped to reels, or locations. While probability distributions are often used to activate special features at various locations of slot machine games, the nature of the prize enhancements described herein often requires a more complex design.

FIG. 2C shows a flow chart of an embodiment that uses persistent special regions in a free spin bonus round. As discussed, one preferred embodiment includes a bonus round of multiple free spins in which every free spin may have at least one special region. A base game round with a free spin award must precede the bonus round, as shown at step 2202. Next, step 2204 starts each free spin with a player activation, although some versions automatically start each free spin without any player activation. Next, the method proceeds to determine a spin outcome using a random number. The method also randomly determines a set of reel stops that determine which symbols fill the matrix for the current game outcome at step 2224. After determining the set of reel stops, the method takes at least one step that uses foreknowledge of the reel stops before the reels stop spinning, as shown at step 2208. This includes at least making a decision whether to use or activate a special region feature depending on whether a designated type of bonus symbols will stop in the symbol array, as shown at step 2208. In different embodiments, there are different conditions to determine whether the special region feature will activate. Similarly to the base game version of the special region feature, in this version the method uses foreknowledge of the spin results to determine if such any conditions are present in the spin result that prevent new special regions being formed, at step 2208. The conditions may vary according to the game rules in both the base game and bonus game embodiments. If so, the method goes to step 2209 where new special regions are not provided, and the reel spin is stopped and evaluated according to the game rules at step 2211.

If, back at step 2208, there are no prohibitive conditions present in the foreknowledge of the spin result, the method goes to step 2212, where it randomly determines whether a special region mystery feature will activate, and if not, goes to step 2209. Preferably, this random determination is made with a single additional random number generation, which is matched to a range to determine a positive or negative answer to activating the special region bonus feature. If activated at step 2214, the method goes to step 2216, where it begins a more detailed sequence of determining exactly how special regions will deploy on the matrix 1001. Note that this is one version of how special regions may be deployed, and many variations exist.

If the special region mystery feature will activate at step 2214, the method next randomly determines how many special regions will be used at step 2216, then for each special region to be used, randomly determining which position(s) of the symbol array will contain the special region. Locations that already have a special region covering them are removed from the random determination of where to place new special regions at step 2218. Next, the method displays the special regions appearing as a mystery feature while the reels are shown to be spinning at step 2220. Note that in the preferred free spin version, special regions are persistent and, once created, are applied to all remaining spins in the free spin bonus round, as shown by the addition of step 2213 which maintains existing special regions from one free spin to the next. This means the display of spinning reels shown while these steps are occurring will continue to show the special regions that previously appeared in the current bonus round. This is done by displaying at least one special region appearing to surround, cover, or include one or more designated locations in the symbol array before the reels stop spinning, and preferably by never removing the graphics indicating a special region. Finally, the method continues to spin the reels for a period of time displaying the special regions in place on the symbol array.

Generally, as described with respect to the base game embodiments above, the use of spin result foreknowledge in the free spin embodiments at step 2208 may use different techniques for determining if the special region feature will deploy. If the method determines to use the special region feature, it will then always display at least one special region appearing to surround, cover, or include one or more designated locations in the symbol array before the reels stop spinning.

Next the method at step 2224 stops the reel spin and goes to step 2226, where the method applies a special feature to any designated symbols that stop in any special regions and evaluates awards that result therefrom.

It should be understood that this is only one example embodiment, and other versions may divide the processing tasks of the game method in a different manner. For example, some systems may employ a thin client architecture in which practically all of the processing tasks are performed at the game server, and only display information for the player interface transmitted to the electronic gaming machine. In such an embodiment, only the steps involving player input or display are performed by the electronic gaming machine, with the remaining steps performed by one of the game servers in the system. In such a case, though, the software architecture is preferably designed as a thin client in which a dedicated virtual machine running on the game server (or a virtual machine server connected in the gaming network) performs the tasks designated in the present drawing as occurring “at the gaming machine.” In the depicted method, the method is performed by the respective computer hardware operating under control of computer program code. While central processor arrangements may vary (for example award controllers may be integrated on the same machine with a gaming server, or may be a separate server connected on a secure network), the particular central determinant architecture is not limiting and will be referred to generally in this drawing as the game server (i.e. 302, 403). As shown at step 2002 in FIG. 2A, the method performed at the game server further includes receiving game play requests originating from electronic gaming machine 100, and sending commands to the gaming machine to show reels spinning, special regions appearing, and results being displayed. The division of game logic steps between gaming machines and servers is known in the art and may be accomplished according to suitable methods allowed for the relevant gaming jurisdictions.

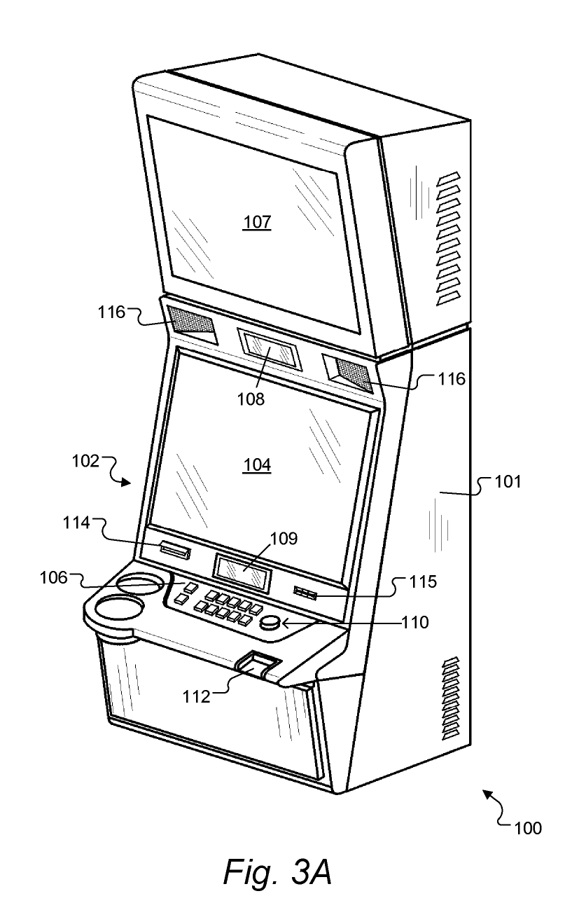

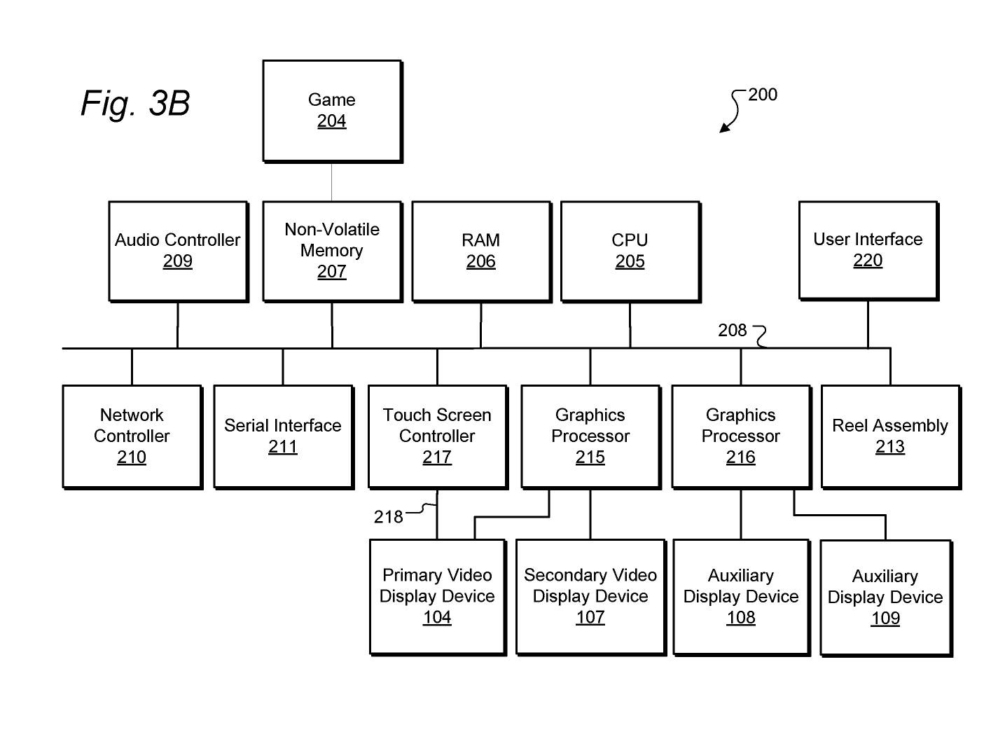

FIG. 3A shows a gaming machine 100 that may be used to implement a special region game according to the present invention. The block diagram of FIG. 3B shows further details of gaming machine 100. Referring to FIG. 3A, gaming machine 100 includes a cabinet 101 having a front side generally shown at reference numeral 102. A primary video display device 104 is mounted in a central portion of the front surface 102, with a ledge 106 positioned below the primary video display device and projecting forwardly from the plane of the primary video display device. In addition to primary video display device 104, the illustrated gaming machine 100 includes a secondary video display device 107 positioned above the primary video display device. Gaming machine 100 also includes two additional smaller auxiliary display devices, an upper auxiliary display device 108 and a lower auxiliary display device 109. It should also be noted that each display device referenced herein may include any suitable display device including a cathode ray tube, liquid crystal display, plasma display, LED display, or any other type of display device currently known or that may be developed in the future.

In preferred versions, the gaming machine 100 illustrated in FIG. 3A also includes a number of mechanical control buttons 110 mounted on ledge 106. These control buttons 110 may allow a player to select a bet level, select pay lines, select a type of game or game feature, and actually start a play in a primary game. Other forms of gaming machines according to the invention may include switches, joysticks, or other mechanical input devices, and/or virtual buttons and other controls implemented on a suitable touch screen video display. For example, primary video display device 104 in gaming machine 100 provides a convenient display device for implementing touch screen controls.

It will be appreciated that gaming machines may also include a number of other player interface devices in addition to devices that are considered player controls for use in playing a particular game. Gaming machine 100 also includes a currency/voucher acceptor having an input ramp 112, a player card reader having a player card input 114, and a voucher/receipt printer having a voucher/receipt output 115. Audio speakers 116 generate an audio output to enhance the user's playing experience. Numerous other types of devices may be included in gaming machines that may be used according to the present invention.

FIG. 3B shows a logical and hardware block diagram 200 of gaming machine 100 which includes a central processing unit (CPU) 205 along with random access memory 206 and nonvolatile memory or storage device 207. All of these devices are connected on a system bus 208 with an audio controller 209, a network controller 210, and a serial interface 211. A graphics processor 215 is also connected on bus 208 and is connected to drive primary video display device 104 and secondary video display device 107 (both mounted on cabinet 101 as shown in FIG. 3A). A second graphics processor 216 is also connected on bus 208 in this example to drive the auxiliary display devices 108 and 109 also shown in FIG. 3A. As shown in FIG. 3B, gaming machine 100 also includes a touch screen controller 217 connected to system bus 208. Touch screen controller 217 is also connected via signal path 218 to receive signals from a touch screen element associated with primary video display device 104. It will be appreciated that the touch screen element itself typically comprises a thin film that is secured over the display surface of primary video display device 104. The touch screen element itself is not illustrated or referenced separately in the figures.

Those familiar with data processing devices and systems will appreciate that other basic electronic components will be included in gaming machine 100 such as a power supply, cooling systems for the various system components, audio amplifiers, and other devices that are common in gaming machines. These additional devices are omitted from the drawings so as not to obscure the present invention in unnecessary detail.

All of the elements 205, 206, 207, 208, 209, 210, and 211 shown in FIG. 3B are elements commonly associated with a personal computer. These elements are preferably mounted on a standard personal computer chassis and housed in a standard personal computer housing which is itself mounted in cabinet 101 shown in FIG. 3A. Alternatively, the various electronic components may be mounted on one or more circuit boards housed within cabinet 101 without a separate enclosure such as those found in personal computers. Those familiar with data processing systems and the various data processing elements shown in FIG. 3B will appreciate that many variations on this illustrated structure may be used within the scope of the present invention. For example, since serial communications are commonly employed to communicate with a touch screen controller such as touch screen controller 217, the touch screen controller may not be connected on system bus 208, but instead include a serial communications line to serial interface 211, which may be a USB controller or a IEEE 1394 controller for example. It will also be appreciated that some of the devices shown in FIG. 3B as being connected directly on system bus 208 may in fact communicate with the other system components through a suitable expansion bus. Audio controller 209, for example, may be connected to the system via a PCI bus. System bus 208 is shown in FIG. 3B merely to indicate that the various components are connected in some fashion for communication with CPU 205 and is not intended to limit the invention to any particular bus architecture. Numerous other variations in the gaming machine internal structure and system may be used without departing from the principles of the present invention.

It will also be appreciated that graphics processors are also commonly a part of modern computer systems. Although separate graphics processor 215 is shown for controlling primary video display device 104, secondary video display device 107, and graphics processor 216 is shown for controlling both auxiliary display devices 108 and 109, it will be appreciated that CPU 205 may control all of the display devices directly without any intermediate graphics processor. The invention is not limited to any particular arrangement of processing devices for controlling the video display devices included with gaming machine 100. Also, a gaming machine implementing the present invention is not limited to any particular number of video display device or other types of display devices.

In the illustrated gaming machine 100, CPU 205 executes software which ultimately controls the entire gaming machine including the receipt of player inputs and the presentation of the graphic symbols displayed according to the invention through the display devices 104, 107, 108, and 109 associated with the gaming machine. As will be discussed further below, CPU 205 either alone or in combination with graphics processor 215 may implement a presentation controller for performing functions associated with a primary game that may be available through the gaming machine and may also implement a game client for directing one or more display devices at the gaming machine to display portions of a special region game according to the present invention. CPU 205 also executes software related to communications handled through network controller 210, and software related to various peripheral devices such as those connected to the system through audio controller 209, serial interface 211, and touch screen controller 217. CPU 205 may also execute software to perform accounting functions associated with game play. Random access memory 206 provides memory for use by CPU 205 in executing its various software programs while the nonvolatile memory or storage device 207 may comprise a hard drive or other mass storage device providing storage for programs not in use or for other data generated or used in the course of gaming machine operation. Network controller 210 provides an interface to other components of a gaming system in which gaming machine 100 is included. In particular, network controller 210 provides an interface to a game controller which controls certain aspects of the special region game as will be discussed below in connection with FIGS. 3A-B.

It should be noted that the invention is not limited to gaming machines employing the personal computer-type arrangement of processing devices and interfaces shown in example gaming machine 100. Other gaming machines through which a special region game is implemented may include one or more special purpose processing devices to perform the various processing steps for implementing the present invention. Unlike general purpose processing devices such as CPU 205, these special purpose processing devices may not employ operational program code to direct the various processing steps.

It should also be noted that the invention is not limited to gaming machines including only video display devices for conveying results. It is possible to implement a special region game within the scope of the present invention using an electro mechanical arrangement or even a purely mechanical arrangement for displaying the symbols needed to complete the special region game as described herein. However, the most preferred forms of the invention utilize one or more video display devices for displaying the spinning reels, the accumulated symbols, and the special region feature. For example, a gaming machine suitable for providing a special region game may include a mechanical reel-type display rather than a video-type display device for displaying results in a primary game, and include a video display device for presenting the special region game as a bonus game.

Still referring to the hardware and logical block diagram 200 showing an example design for a gaming machine 100, the depicted machine in operation is controlled generally by CPU 205 which stores operating programs and data in memory 207 with wagering game 204, user interface 220, network controller 210, audio/visual controllers, and reel assembly 213 (if mechanical reel configuration). CPU or game processor 205 may comprise a conventional microprocessor, such as an Intel® Pentium® microprocessor, mounted on a printed circuit board with supporting ports, drivers, memory, software, and firmware to communicate with and control gaming machine operations, such as through the execution of coding stored in memory 207 including one or more wagering games 204. Game processor 205 connects to user interface 220 such that a player may enter input information and game processor 205 may respond according to its programming, such as to apply a wager and initiate execution of a game.

Game processor 205 also may connect through network controller 210 to a gaming network, such as example casino server network 400 shown in FIG. 4B. Referring now to FIG. 4B, the casino server network 400 may be implemented over one or more site locations and include host server 401, remote game play server 403 (which may be configured to provide game processor functionality including determining game outcomes and providing audio/visual instructions to a remote gaming device), central determination server 405 (which may be configured to determine lottery, bingo, or other centrally determined game outcomes and provide the information to networked gaming machines 100 providing lottery and bingo-based wagering games to patrons), progressive server 407 (which may be configured to accumulate a progressive pool from a portion of wagering proceeds or operator marketing funds and to award progressive awards upon the occurrence of a progressive award winning event to one or more networked gaming machines 100), player account server 409 (which may be configured to collect and store player information and/or awards and to provide player information to gaming machines 100 after receiving player identification information such as from a player card), and accounting server 411 (which may be configured to receive and store data from networked gaming machines 100 and to use the data to provide reports and analyses to an operator). Through its network connection, gaming machine 100 may be monitored by an operator through one or more servers such as to assure proper operation, and, data and information may be shared between gaming machine 100 and respective of the servers in the network such as to accumulate or provide player promotional value, to provide server-based games, or to pay server-based awards.

Referring now to FIG. 4A, a gaming system 300 according to another embodiment of the present invention is shown again in a network and system diagram format. System 300 includes a number of gaming machines, each comprising a gaming machine 100 in this example implementation. For purposes of describing system 300, each gaming machine 100 in FIG. 4A is shown as including a video display device 107 and a player interface that may include buttons, switches, or other physical controls and/or touch screen controls as discussed above in connection with FIG. 4A. This player interface is labeled 301 in FIG. 4A. System 300 further includes a game server 302 and a respective game client 303 (abbreviated “GC” in FIG. 4A) included with each respective gaming machine 100. In the form of the invention shown in FIG. 4A these two components, game server 302 and the game client components 303 combine to implement a game control arrangement which will be described in detail below. System 300 also includes an award controller 305, which is shown in FIG. 4A as being associated with game server 302 to indicate that the two components may be implemented through a common data processing device/computer system. Gaming machines 100, game server 302, and award controller 305 are connected in a network communication arrangement including first and second network switches 306 and 307, connected together through various wired or wireless signal paths, all shown as communications links 308 in FIG. 4A.

Each gaming machine 100, and particularly player interface 301 associated with each gaming machine, allows a player to make any inputs that may be required to make the respective gaming machine eligible for a special region game, and make selections of any selectable objects displayed at the respective gaming machine in the course of the special region game. Player interface 301 also allows a player at the gaming machine to initiate plays in a primary game available through the gaming machine in some implementations. The respective video display device 107 associated with each respective gaming machine 100 is used according to the invention to generate the graphic displays to show the various elements of a special region game at the respective gaming machine.

The game control arrangement made up of game server 302 and the respective game client 303 at a given gaming machine functions to control the respective video display device 107 for that gaming machine to display a special region graphic and a number of selectable objects. Award controller 305 is responsible for awarding prizes for a player's participation in a special region game, and maintaining progressive prize information where the special region game offers one or more progressive prizes. The network arrangement made up of network switches 306 and 307, and the various communication links 308 shown in FIG. 4A is illustrated merely as an example of a suitable communications arrangement. It should be noted that the game control arrangement, or as it is referred to generally the “game controller,” may be implemented in some embodiments entirely on the gaming machine. This is especially true in jurisdictions that allow Class III gaming conducted with random number generators at each gaming machine. The present invention is not limited to any particular communications arrangement for facilitating communications between game server 302 and various gaming machines 100. Any wired or wireless communication arrangement employing any suitable communications protocols (such as TCP/IP for example) may be used in an apparatus according to the invention.

FIG. 4A shows other server(s) 310 included in the network. This illustrated “other server(s)” element 310 may include one or more data processing devices for performing various functions related to games conducted through system 300 and any other games that may be available to players through gaming machines 100. For example, apparatus 300 may be accounting servers providing support for cashless gaming or various forms of mixed cash/cashless gaming through the various gaming machines 100. In this example, an additional one of the other servers 310 will be included in apparatus 300 for supporting these types of wagering and payout systems. As another example, the various gaming machines 100 included in system 300 may allow players to participate in a game (primary game) other than the special region game described herein, and this other game may rely on a result identified at or in cooperation with a device that is remote from the gaming machines. In this example, another server 310 may be included in the system for identifying results for the primary game and communicating those results to the various gaming machines 100 as necessary. Generally, the other server(s) 310 shown in FIG. 4A are shown only to indicate that numerous other components may be included along with the elements that participate in providing special region games according to the present invention. Other server(s) 310 may provide record keeping, player tracking, accounting, result identifying services, or any other services that may be useful or necessary in a gaming system.

Referring to FIG. 4B, a block diagram of another example networked gaming system 400 associated with one or more gaming facilities is shown, including one or more networked gaming machines 100 in accordance with one or more embodiments. With reference to FIG. 4B, while a few servers have been shown separately, they may be combined or split into additional servers having additional capabilities.

As shown, networked gaming machines 100 (EGM1-EGM4) and one or more overhead displays 413 may be network connected and enable the content of one or more displays of gaming machines 100 to be mirrored or replayed on an overhead display. For example, the primary display content may be stored by the display controller or game processor 205 and transmitted through network controller 210 to the overhead display controller either substantially simultaneously or at a subsequent time according to either periodic programming executed by game processor 205 or a triggering event, such as a jackpot or large win, at a respective gaming machine 100. In the event that gaming machines 100 have cameras installed, the respective players' video images may be displayed on overhead display 413 along with the content of the player's display 100 and any associated audio feed.

In one or more embodiments, game server 403 may provide server-based games and/or game services to network connected gaming devices, such as gaming machines 100 (which may be connected by network cable or wirelessly). Progressive server 407 may accumulate progressive awards by receiving defined amounts (such as a percentage of the wagers from eligible gaming devices or by receiving funding from marketing or casino funds) and provide progressive awards to winning gaming devices upon a progressive event, such as a progressive jackpot game outcome or other triggering event such as a random or pseudo-random win determination at a networked gaming device or server (such as to provide a large potential award to players playing the community feature game). Accounting server 411 may receive gaming data from each of the networked gaming devices, perform audit functions, and provide data for analysis programs, such as the IGT Mariposa program bundle.

Player account server 409 may maintain player account records, and store persistent player data such as accumulated player points and/or player preferences (e.g. game personalizing selections or options). For example, the player tracking display may be programmed to display a player menu that may include a choice of personalized gaming selections that may be applied to a gaming machine 100 being played by the player.

In one or more embodiments, the player menu may be programmed to display after a player inserts a player card into the card reader. When the card reader is inserted, an identification may be read from the card and transmitted to player account server 409. Player account server 409 transmits player information through network controller 210 to user interface 220 for display on the player tracking display. The player tracking display may provide a personalized welcome to the player, the player's current player points, and any additional personalized data. If the player has not previously made a selection, then this information may or may not be displayed. Once the player makes a personalizing selection, the information may be transmitted to game processor 205 for storing and use during the player's game play. Also, the player's selection may be transmitted to player account server 409 where it may be stored in association with the player's account for transmission to the player in future gaming sessions. The player may change selections at any time using the player tracking display (which may be touch sensitive or have player-selectable buttons associated with the various display selections).

In one or more embodiments, a gaming website may be accessible by players, e.g. gaming website 421, whereon one or more games may be displayed as described herein and played by a player such as through the use of personal computer 423 or handheld wireless device 425 (e.g. Blackberry® cell phone, Apple® iPhone®, personal data assistant (PDA), iPad®, etc.). To enter the website, a player may log in with a username (that may be associated with the player's account information stored on player account server 409 or be accessible by a casino operator to obtain player data and provide promotional offers), play various games on the website, make various personalizing selections, and save the information, so that during a next gaming session at a casino establishment, the player's playing data and personalized information may be associated with the player's account and accessible at the player's selected gaming machine 100.

Any use of ordinal terms such as “first,” “second,” “third,” etc., to refer to an element does not by itself connote any priority, precedence, or order of one element over another, or the temporal order in which acts of a method are performed. Rather, unless specifically stated otherwise, such ordinal terms are used merely as labels to distinguish one element having a certain name from another element having a same name (but for use of the ordinal term).

Further, as described herein, the various features have been provided in the context of various described embodiments, but may be used in other embodiments. The combinations of features described herein should not be interpreted to be limiting, and the features herein may be used in any working combination or sub-combination according to the invention. This description should therefore be interpreted as providing written support, under U.S. patent law and any relevant foreign patent laws, for any working combination or some sub-combination of the features herein.

The above described preferred embodiments are intended to illustrate the principles of the invention, but not to limit the scope of the invention. Various other embodiments and modifications to these preferred embodiments may be made by those skilled in the art without departing from the scope of the present invention.

1. A method of providing a wagering game on a gaming machine having a display, a wager input device, and at least one electronic controller operatively coupled to the wager input device and the display and configured to execute instructions related to the wagering game, the method comprising:
receiving a wager from a player at the wager input device, receiving a game activation at the gaming machine, and in response initiating the wagering game;
after initiating the wagering game, displaying the reels spinning;
generating at least one random number and using the at least one random number to determine a set of game reel stops specifying a position in which multiple simulated or mechanical reels will stop to display symbols in a symbol array in a spin outcome for the wager;
after determining the set of base game reel stops, using foreknowledge of the reel stops to make a decision whether to use a special region feature depending on whether a designated type of bonus symbol will stop in the symbol array;
if the decision determines to use the special region feature displaying at least one special region appearing to surround, cover, or include one or more designated locations in the symbol array before the reels stop spinning;
applying a special feature to any designated symbols that stop in any special regions and evaluating awards that result therefrom; and
evaluating the spin outcome on the symbol array.

2. The method of claim 1, in which the decision using foreknowledge of the reel stops further includes determining locations for at least one proposed special region and determining if any of a designated type of symbols would fall in the proposed special region(s), and making a game flow decision based on that determination before the reels stop spinning.

3. The method of claim 2, in which the game flow decision decides not to use the special region feature with the proposed special regions.

4. The method of claim 3, in which the game flow decision further decides not to use the special region feature at all.

5. The method of claim 1, further comprising generating a first additional random number specifically to determine how many symbol locations will be covered by special region(s).

6. The method of claim 5, further comprising generating a second additional random number(s) to determine which symbol(s) locations will be included in the special region(s).

7. The method of claim 1, wherein applying the special region to any designated symbols includes providing a specific award if a designated symbol lands in a special region, the specific award being independent of any other award provided for the spin outcome.

8. The method of claim 1, wherein the special regions are persistent across at least two spins.

9. The method of claim 8, wherein the special regions persist for all remaining spins in a free spin bonus round.

10. A method of providing a wagering game on a gaming machine having a display, a wager input device, and at least one electronic controller operatively coupled to the wager input device and the display and configured to execute instructions related to the wagering game, the method comprising:
receiving a wager from a player at the wager input device, receiving a game activation at the gaming machine, and in response initiating the wagering game;
after initiating the wagering game, displaying the reels spinning;
generating at least one random number and using the at least one random number to determine a set of game reel stops specifying a position in which multiple simulated or mechanical reels will stop to display symbols in a symbol array in a spin outcome for the wager;
after determining the set of base game reel stops,
(a) using foreknowledge of the reel stops to determine if symbols to be displayed in the symbol array include any of a designated type of bonus symbol or designated combination of bonus symbols, and if so, going to a step that skips activating a special region feature of the game,
(b) if not, randomly determining whether a special region mystery feature will activate, and if not, going to the step that skips activating the special region feature of the game,
(c) if the special region mystery feature will activate at (b),
(i) randomly determining how many special regions will be used;
(ii) for each special region to be used, randomly determining which position(s) of the symbol array will contain the special region;
(iii) displaying the special regions appearing as a mystery feature while the reels are spinning;
(iv) continuing to spin the reels for a period of time displaying the special regions in place on the symbol array;
(v) stopping the reels spinning;
(vi) applying a special feature to designated symbols that stop in the special regions and evaluating awards that result therefrom;
(vii) evaluating the spin outcome on the symbol array;
(d) if the method skips activating the special region feature, stopping the reels spinning and evaluating the spin outcome on the symbol array.

11. The method of claim 10, in which the decision using foreknowledge of the reel stops further includes determining locations for at least one proposed special region and determining if any of a designated type of symbols would fall in the proposed special region(s), and making a game flow decision based on that determination before displaying the reels stopping spinning.

12. The method of claim 11, in which the game flow decision decides not to use the special region feature with the proposed special regions.

13. The method of claim 12, in which the game flow decision further decides not to use the special region feature at all.

14. The method of claim 10 wherein applying the special region to any designated symbols includes providing an independent award if a designated symbol lands in a special region, the independent award being independent of any other award provided for the spin outcome.

15. A system for providing a wagering game for a player, the system comprising an electronic gaming machine interacting with at least one server, a display, a wager input device, and at least one electronic controller operatively coupled to the wager input device and the display and configured to execute instructions related to the wagering game, the system programmed for:
receiving a wager from a player at the wager input device, receiving a game activation at the gaming machine, and in response initiating the wagering game;
after initiating the wagering game, displaying the reels spinning;
generating at least one random number and using the at least one random number to determine a set of game reel stops specifying a position in which multiple simulated or mechanical reels will stop to display symbols in a symbol array in a spin outcome for the wager;
after determining the set of base game reel stops, using foreknowledge of the reel stops to making a decision whether to use a special region feature depending on whether a designated type of bonus symbol or combination of bonus symbols will stop in the symbol array;
if the method determines to use the special region feature displaying at least one special region appearing to surround, cover, or include one or more designated locations in the symbol array before the reels stop spinning;
applying a special feature to any designated symbols that stop in any special regions and evaluating awards that result therefrom;
evaluating the spin outcome on the symbol array.

16. The system of claim 15, in which the decision using foreknowledge of the reel stops further includes determining locations for at least one proposed special region and determining if any of a designated type of symbol would fall in the proposed special region(s), and making a game flow decision based on that determination before the reels stop spinning.

17. The system of claim 16, in which the game flow decision decides not to use the special region feature with the proposed special regions.

18. The system of claim 17, in which the game flow decision further decides not to use the special region feature at all.

19. The system of claim 15, further comprising generating a first additional random number specifically to determine how many symbol locations will be covered by special region(s).

20. The system of claim 19, further comprising generating a second additional random numbers to determine which symbol locations will be included in the special region(s).

21. The system of claim 15 wherein applying the special region to any designated symbols includes providing a specific award if a designated symbol lands in a special region, the specific award being independent of any other award provided for the spin outcome.
